(19) United States
(12) Patent Application Publication
(10) Pub. No.: US 2006/0098553 A1
(43) Pub. Date: May 11, 2006

(54) Beam splitter and optical pickup device

(75) Inventor: Hiroshi Hirayama, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/263,864

(22) Filed: Nov. 2, 2005

(30) Foreign Application Priority Data
Nov. 9, 2004 (JP) JP2004-325167

(51) Int. Cl. G11B 7/00

(52) U.S. Cl. 369/112.01

(57) ABSTRACT

A beam splitter, comprises: a light source light entering side prism to which a light from a light source enters; a reflected light entering side prism to which a reflected light from an information recording medium enters; a multi layer film provided between the light source light entering side prism and the reflected light entering side prism, wherein the multi layer film comprises a plurality of specific laminated sections each of which comprises a low refractive index layer, a medium refractive index layer, and a high refractive index layer in this order from the reflected light entering side.

This application is based on Japanese Patent application No. 2004-325167 filed on Nov. 9, 2004, in Japanese Patent Office, the entire content of which is hereby incorporated by reference.

### BACKGROUND OF THE INVENTION

The present invention relates to a beam splitter and an optical pickup device equipped with the same.

A movement toward high performance and miniaturization of an optical pickup device used for a magneto-optical disc and others have been advanced in recent years. As one of the methods for miniaturization, there is given a method wherein a light flux emitted from a laser light source enters a beam splitter as finite light, and after being transmitted through a beam splitter, it is converted by a collimator lens into infinite light to enter an objective lens. There is further a method wherein a collimator lens is omitted, and a light flux enters an objective lens as finite light. When causing finite light to enter a beam splitter, it is necessary to make incident-angle-dependency for reflectance, transmittance and a reflection phase difference to be small, and the method therefor is disclosed in Patent Document 1.

(Patent Document 1) TOKKAIHEI No. 7-5324

In the Patent Document 1, however, a reflection phase difference of each of S polarized light and P polarized light of the reflected light is represented by none of 0°, 90°, 180° and 270°. It is preferable that a reflection phase difference of a beam splitter is 0° and 90° or 180° and 270°, and when the beam splitter has a reflection phase difference other than the above values, it is necessary to use methods for using a wavelength plate prepared specifically or for changing the structure of a signal detecting portion, which is different from an ordinary half wavelength plate or quarter wavelength plate. When employing this method, there is caused a problem of cost increase, because adjustment becomes more difficult and the number of parts is increased. As stated above, it has been impossible to make incident-angle-dependency for reflectance, transmittance and reflection phase difference to be small, without using the special structure, and it has been impossible to make incident-angle-dependency for reflectance, transmittance and reflection phase difference to be small in an ordinary structure, which has been a problem.

In general, a laser beam has temperature-dependency and a wavelength of a light flux varies depending on temperatures, and therefore, wavelength-dependency of a beam splitter needs to be small. However, in the Patent Document 1, there is no description about aforesaid matters, and the structure in a sufficiently necessary range wherein wavelength-dependency for reflectance, transmittance and reflection phase difference is considered, is not disclosed.

As stated above, wavelength-dependency for reflectance, transmittance and for reflection phase difference and incident-angle-dependency for reflectance, transmittance and reflection phase difference need to be small, for the beam splitter. However, the beam splitter satisfying the aforesaid conditions and an optical pickup device employing that beam splitter have not been suggested in the past.

### SUMMARY OF THE INVENTION

Accordingly, an object of the invention is to provide a beam splitter wherein wavelength-dependency for reflectance, transmittance and reflection phase difference and incident-angle-dependency for reflectance, transmittance and for reflection phase difference of a beam splitter provided on an optical pickup device such as a magneto-optical disc, can be made small, and to provide an optical pickup device equipped with the aforesaid beam splitter.

Structure 1

A beam splitter having therein an illuminant light entering side prism where light from a light source enters and a reflected light entering side prism where light reflected on an information recording medium enters, wherein there is provided, between the illuminant light entering side prism and the reflected light entering side prism, a multilayer coating having thereon plural specific laminated portions each having thereon a low refractive index layer, a medium refractive index layer, and a high refractive index layer, in this order from the reflected light entering side.

In the invention described in Structure 1, a beam splitter is provided with the illuminant light entering side prism where light from a light source enters and the reflected light entering side prism where light reflected on an information recording medium enters, and the multilayer coating having thereon plural specific laminated portions each having thereon a low refractive index layer, a medium refractive index layer, and a high refractive index layer, in this order from the reflected light entering side, is provided between the illuminant light entering side prism and the reflected light entering side prism, therefore, it is possible to make wavelength-dependency for reflectance, transmittance and reflection phase difference and incident-angle-dependency for reflectance, transmittance and for reflection phase difference of a beam splitter to be small.

A thickness of each specific laminated portion in the plural specific laminated portions does not need to be the same and a thickness of a specific laminated portion with the same refractive index does not need to be the same, and they may be different depending on the specification to be obtained. Further, a thickness of each layer in each specific laminated portion does not need to be the same, and it may be different depending on the specification to be obtained. In addition, though a plurality of specific laminated portions are not always provided continuously, it is preferable that they are provided continuously.

Structure 2

The beam splitter according to Structure 1 wherein reflectance Rs of S polarized light of reflected light outputted in the prescribed direction after light reflected on the information recording medium enters satisfies Rs≧90%, and reflectance Rp of P polarized light of reflected light outputted in the prescribed direction after light from a light source enters and reflectance R′p of P polarized light of reflected light outputted in the prescribed direction after light reflected on the information recording medium respectively satisfy 10%≦Rp≦40% and 10%≦R′p≦40%.

In the invention described in Structure 2, reflectance Rs of S polarized light of reflected light outputted in the prescribed direction after light reflected on the information recording medium enters satisfies Rs≧90%, and reflectance Rp of P polarized light of reflected light outputted in the prescribed direction after light from a light source enters and reflectance R′p of P polarized light of reflected light outputted in the prescribed direction after light reflected on the information recording medium respectively satisfy 10%≦Rp≦40% and 10%≦R′p≦40%, thereby, it is possible to cause P polarized light having an appropriate amount of light to be reflected and to cause S polarized light having a large amount of light to be reflected.

Incidentally, “prescribed direction” means the direction in which the reflected light needed for detection is outputted when detecting the reflected light.

Structure 3

The beam splitter according to Structure 1 or Structure 1 wherein a material whose main component is MgF₂ or SiO₂ is used for the low refractive index layer, a material whose main component is any one of Al₂O₃, Y₂O₃, SiO₂ and Si₂O₃ is used for the medium refractive index layer, and a material whose main component is any one of TiO₂, Ta₂O₅, ZrO₂, Nb₂O₃, CeO₂, CeF₃, HfO₂ and ZrTiO₄ is used for the high refractive index layer.

In the invention described in Structure 3, a material whose main component is MgF₂ or SiO₂ is used for the low refractive index layer, a material whose main component is any one of Al₂O₃, Y₂O₃, SiO₂ and Si₂O₃ is used for the medium refractive index layer, and a material whose main component is any one of TiO₂, Ta₂O₅, ZrO₂, Nb₂O₃, CeO₂, CeF₃, HfO₂ and ZrTiO₄ is used for the high refractive index layer, which makes it possible to employ the structure wherein wavelength-dependency for reflectance, transmittance and reflection phase difference and incident-angle-dependency for reflectance, transmittance and reflection phase difference of a beam splitter can be made small specifically.

Meanwhile, “main component” in the material to be used is a component that occupies 50% by mass or more of the material. As each material to be used, those wherein main component in the material is 90% by mass or more are preferable, and those wherein main component in the material is 100%, namely, those composed only of main component are more preferable.

Structure 4

The beam splitter according to Structure 3 wherein a material whose main component is MgF₂ is used for the low refractive index layer, a material whose main component is Al₂O₃ is used for the medium refractive index layer, and a material whose main component is TiO₂ is used for the high refractive index layer.

In the invention described in Structure 4, a material whose main component is MgF₂ is used for the low refractive index layer, a material whose main component is Al₂O₃ is used for the medium refractive index layer and a material whose main component is TiO₂ is used for the high refractive index layer, thus, it is possible to make a difference of refractive index between the low refractive index layer and the high refractive index layer to be large. Specifically, when the low refractive index layer and the high refractive index layer are constituted respectively with MgF₂ and TiO₂, a difference of refractive index can be made to be as great as 0.88, whereby, the number of layers constituting the multilayer can be reduced, which is a merit.

Structure 5

The beam splitter according to Structure 3 wherein a material whose main component is MgF₂ is used for the low refractive index layer, a material whose main component is Al₂O₃ is used for the medium refractive index layer, and a material whose main component is Ta₂O₅ is used for the high refractive index layer.

In the invention described in Structure 5, a material whose main component is MgF₂ is used for the low refractive index layer, a material whose main component is Al₂O₃ is used for the medium refractive index layer and a material whose main component is Ta₂O₅ is used for the high refractive index layer, thus, it is possible to lighten the stress of the whole layers by laminating respective layers having respectively MgF₂ and Al₂O₃ each having tensile stress and a layer having a main component of Ta₂O₃ having compression stress, and thereby, to achieve a multilayer film excellent in terms of environmental resistance on which peeling and cracks are hardly caused.

Structure 6

The beam splitter according to Structure 3 wherein a material whose main component is SiO₂ is used for the low refractive index layer, a material whose main component is Al₂O₃ is used for the medium refractive index layer, and a material whose main component is TiO₂ is used for the high refractive index layer.

In the invention described in Structure 6, a material whose main component is SiO₂ is used for the low refractive index layer, a material whose main component is Al₂O₃ is used for the medium refractive index layer and a material whose main component is TiO₂ is used for the high refractive index layer, thus, it is possible to lighten the stress of the whole layers by laminating a layer having a main component of SiO₂ having compression stress and respective layers having respectively Al₂O₃ and TiO₂ each having tensile stress, and thereby, to achieve a multilayer film excellent in terms of environmental resistance on which peeling and cracks are hardly caused.

Structure 7

The beam splitter according to any one of Structures 1-6 wherein a difference of refractive index between an adhesive used for cementing of the illuminant light entering side prism, the multilayer film and the reflected light entering side prism and the reflected light entering side prism is not more than 0.1.

In the invention described in Structure 7, a difference of refractive index between an adhesive used for cementing of the illuminant light entering side prism, the multilayer film and the reflected light entering side prism and the reflected light entering side prism is not more than 0.1, therefore, when two prisms are cemented together by adhesives, deterioration of wavefront aberration is less, and efficiency percentage of beam splitters can be improved, even when a certain wedge angle of an adhesion layer is caused by uneven thickness of the adhesion layer.

Structure 8

The beam splitter according to any one of Structures 1-7 wherein reflection phase difference Δ between S polarized light and P polarized light satisfies −10°≦Δ≦10° or 170°≦Δ≦190°.

In the invention described in Structure 8, reflection phase difference Δ between S polarized light and P polarized light satisfies −10°≦Δ≦10° or 170°≦Δ≦190°, therefore, an angle of Kerr rotation for a magneto-optical recording medium can be detected accurately, and excellent recording and reproducing characteristics can be obtained.

Structure 9

The beam splitter according to any one of Structures 1-7 wherein reflection phase difference Δ between S polarized light and P polarized light satisfies 80°≦Δ≦100° or 260°≦Δ≦280°.

In the invention described in Structure 9, reflection phase difference Δ between S polarized light and P polarized light satisfies 80°≦Δ≦100° or 260°≦Δ≦280°, therefore, an angle of Kerr rotation for a magneto-optical recording medium can be detected accurately, and excellent recording and reproducing characteristics can be obtained.

Structure 10

An optical pickup device wherein there is provided a beam splitter described in any one of Structures 1-9.

In the invention described in Structure 10, excellent recording and reproducing characteristics are obtained, because the optical pickup device is provided with a beam splitter described in any one of Structures 1-9.

Structure 11

An optical pickup device wherein the beam splitter described in Structure 8 and a half wavelength plate are provided.

In the invention described in Structure 11, excellent recording and reproducing characteristics are obtained, and cost can be controlled, because the optical pickup device is provided with a beam splitter described in Structure 8 and a half wavelength plate are provided.

Structure 12

An optical pickup device wherein the beam splitter described in Structure 9 and a quarter wavelength plate are provided.

In the invention described in Structure 12, excellent recording and reproducing characteristics are obtained, and cost can be controlled, because the optical pickup device is provided with a beam splitter described in Structure 9 and a quarter wavelength plate are provided.

Structure 13

The optical pickup device according to any one of Structures 10-12 wherein divergent light emitted from the light source enters the beam splitter.

In the invention described in Structure 13, excellent recording and reproducing characteristics are obtained, and the optical pickup device can be made small, because divergent light emitted from the light source enters the beam splitter.

In the invention, an apparatus equipped with an optical pickup device can be miniaturized while it keeps having an excellent performance.

### BRIEF DESCRIPTION OF THE DRAWINGS

FIG. 1 is a diagram showing schematically an optical pickup device exemplified as an embodiment to which the invention is applied.

FIG. 2 is a diagram showing schematically a beam splitter exemplified as an embodiment to which the invention is applied.

FIG. 3 is a diagram showing schematically an optical pickup device exemplified as another embodiment to which the invention is applied.

FIG. 4 is a graph showing relationship between a wavelength and a reflectance when light enters the beam splitter in the first embodiment at an angle of incidence of 45°.

FIG. 5 is a graph showing relationship between a wavelength and a reflection phase difference when light enters the beam splitter in the first embodiment at an angle of incidence of 45°.

FIG. 6 is a graph showing relationship between an angle of incidence and reflectance when the light having a wavelength of 685 nm enters the beam splitter in the first embodiment.

FIG. 7 is a graph showing relationship between an angle of incidence and a reflection phase difference when the light having a wavelength of 685 nm enters the beam splitter in the first embodiment.

FIG. 8 is a graph showing relationship between a wavelength and a reflectance when light enters the beam splitter in the second embodiment at an angle of incidence of 45°.

FIG. 9 is a graph showing relationship between a wavelength and a reflection phase difference when light enters the beam splitter in the second embodiment at an angle of incidence of 45°.

FIG. 10 is a graph showing relationship between an angle of incidence and reflectance when the light having a wavelength of 685 nm enters the beam splitter in the second embodiment.

FIG. 11 is a graph showing relationship between an angle of incidence and a reflection phase difference when the light having a wavelength of 685 nm enters the beam splitter in the second embodiment.

FIG. 12 is a graph showing relationship between a wavelength and a reflectance when light enters the beam splitter in the third embodiment at an angle of incidence of 45°.

FIG. 13 is a graph showing relationship between a wavelength and a reflection phase difference when light enters the beam splitter in the third embodiment at an angle of incidence of 45°.

FIG. 14 is a graph showing relationship between an angle of incidence and reflectance when the light having a wavelength of 685 nm enters the beam splitter in the third embodiment.

FIG. 15 is a graph showing relationship between an angle of incidence and a reflection phase difference when the light having a wavelength of 685 nm enters the beam splitter in the third embodiment.

FIG. 16 is a graph showing relationship between a wavelength and a reflectance when light enters the beam splitter in the fifth embodiment at an angle of incidence of 45°.

FIG. 17 is a graph showing relationship between a wavelength and a reflection phase difference when light enters the beam splitter in the fifth embodiment at an angle of incidence of 45°.

FIG. 18 is a graph showing relationship between an angle of incidence and reflectance when the light having a wavelength of 685 nm enters the beam splitter in the fifth embodiment.

FIG. 19 is a graph showing relationship between an angle of incidence and a reflection phase difference when the light having a wavelength of 685 nm enters the beam splitter in the fifth embodiment.

### DETAILED DESCRIPTION OF THE PREFERRED EMBODIMENT

The specific embodiment of the invention will be explained as follows, referring to the drawings. However, the invention is not limited only to those illustrated.

### First Embodiment

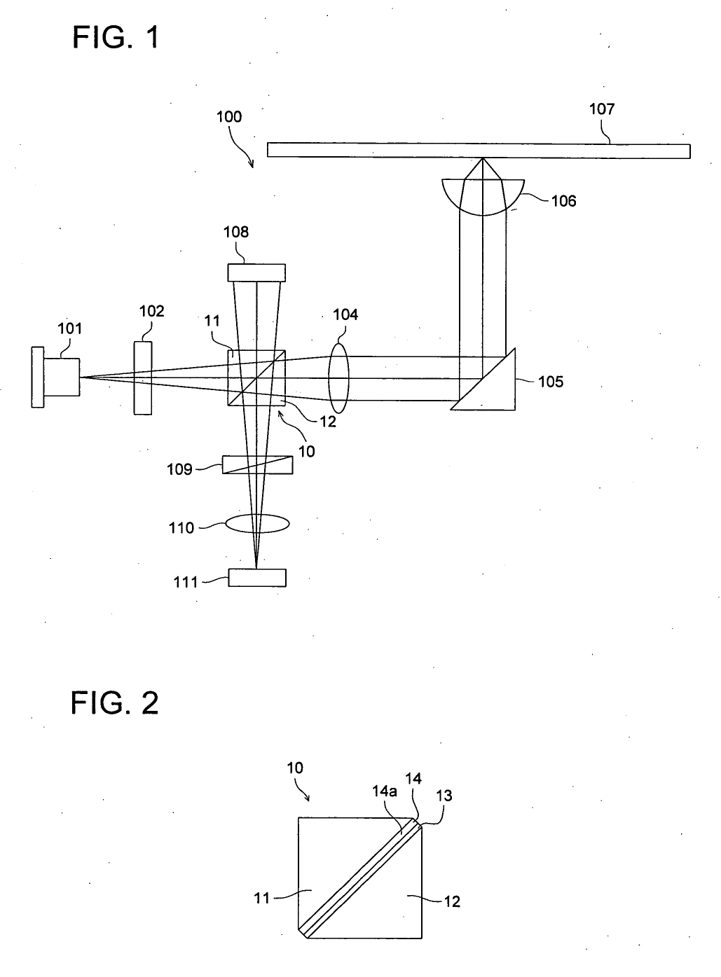

FIG. 1 is a diagram showing schematically optical pickup device 100 relating to the first embodiment to which the invention is applied.

The optical pickup device 100 is a device wherein information is recorded on a magneto-optical disc when irradiating the magneto-optical disc with a laser beam to give energy of Curie point or higher to the magneto-optical disc and thereby to give magnetism corresponding to the direction of magnetism of external magnetic field in the direction perpendicular to the magneto-optical disc, while, information is reproduced by detecting changes in P polarized light component and S polarized light component of reflected light coming from the magneto-optical disc, by utilizing that a plane of polarization of a laser beam is slightly rotated by Kerr effect depending on the direction of magnetism of magneto-optical disc 107.

The optical pickup device 100 of the present embodiment is provided with laser diode 101 representing a light source, diffraction plate 102, beam splitter 10 (detailed structure will be explained later) composed of illuminant light entering side prism 11 and reflected light entering side prism 12, collimator lens 104, laser mirror 105, objective lens 106, magneto-optical disc 107 representing an information recording medium, photodetector 108, 3-beam-Wollaston prism 109, cylindrical lens 110, and with photodector 111.

An occasion to reproduce information recorded on the magneto-optical disc 107 will be explained next.

A plane of vibration of the electric field of the linearly polarized light emitted from laser diode 101 is established to be in parallel with a plane of incidence of the illuminant light entering side prism 11 of the beam splitter 10. After the linearly polarized light emitted from laser diode 101 passes through the diffraction plate 102, a reflected light of a part of the linearly polarized light enters the photodetector 108, and the rest of transmitted light is converged on the magneto-optical disc 107 through the collimator lens 104, the laser mirror 105 and the objective lens 106.

Light reflected on the magneto-optical disc 107 is subjected to Kerr rotation in the direction of magnetization, then its plane of vibration is rotated slightly, and enters the beam splitter 10 again through the objective lens 106, the laser mirror 105 and the collimator lens 104. While, incident light coming from the laser diode 101 is P polarized light, returning light (reflected light) from the magneto-optical disc is divided into P polarized light component and S polarized light component because the returning light is subjected to Kerr rotation, then, a fixed amount of light for each of P polarized light component and S polarized light component is reflected by the beam splitter 10, thus, the P polarized light component and S polarized light component pass through, 3-beam-Wollaston prism 109, and cylindrical lens 110, to enter the photodector 111. Incidentally, a beam is divided into plural portions by diffraction plate 102 and 3-beam-Wollaston prism 109, and tracking servo signal and differential signal for P polarized light component and S polarized light component are detected by photodetector 111 (OEIC, Optical Electronic IC).

Next, the beam splitter relating to the first embodiment will be explained.

FIG. 2 is a diagram showing schematically beam splitter 10 relating to the first embodiment.

The beam splitter 10 is composed of illuminant light entering side prism 11 representing a rectangular prism arranged on the side where the light emitted from a light source such as laser diode 101 enters, reflected light entering side prism 12 representing a rectangular prism arranged on the side where the reflected light resulting from the illuminant light that enters from the illuminant light entering side prism 11 and passes through beam splitter 10 to be reflected on the magneto-optical disc 107 enters, multilayer film 13 formed on a slant of the reflected light entering side prism 12 between these two rectangular prisms, and adhesion layer 14 made of UV curing adhesive agent 14a that joins the reflected light entering side prism 12 on which the multilayer film 13 is formed and the illuminant light entering side prism 11.

Each of the illuminant light entering side prism 11 and the reflected light entering side prism 12 is made of the same glass material (made by Ohara Co., Product name: S-TIM22, n=1.64). Refractive index n of the UV curing adhesive agent 14a is 1.60.

In this case, when two prisms 11 and 12 are cemented with the UV curing adhesive agent 14a, if a thickness of the adhesion layer 14 is uneven, a wedge angle of the adhesion layer is caused undesirably. If refractive index of the glass material is further different greatly from that of adhesive agents in this case, deterioration of wavefront aberration is caused. For example, if refractive index n of the adhesive agent is 1.51 for refractive index n of the glass material which is 1.64, and wedge angle of the adhesion layer 0.2° is caused, the wavefront aberration is deteriorated by 0.08 rmsλ undesirably. However, if a difference of refractive index between the glass material and adhesive agents is zero, wavefront aberration is not deteriorated even when a wedge angle of the adhesion layer is caused. Therefore, it is desirable that a difference of refractive index between the glass material and adhesive agents is small as far as possible. Therefore, if a difference of refractive index between the glass material and adhesive agents is made to be 0.1 or less, deterioration of wavefront aberration can be less even when a wedge angle of an adhesion layer on a level of those caused in an ordinary adhesion process is caused, and efficiency percentage of beam splitters can be improved.

Next, multilayer film 13 of beam splitter 10 relating to the first embodiment will be explained.

Multilayer film 13 of the present embodiment is a coated film provided on a slant of the reflected light entering side prism 12 as stated above, and it is formed to have the structure shown in Table 1.

TABLE 1

| | | Refractive | Layer |
|---|---|---|---|
| No. | | index | thickness (nm) |
| | Illuminant light entering | 1.64 | |
| | side prism (S-TIM22) | | |
| | UV curing adhesive agent | 1.6 | |
| 15 | TiO₂ | 2.26 | 50.31 |
| 14 | MgF₂ | 1.38 | 85.72 |
| 13 | TiO₂ | 2.26 | 49.53 |
| 12 | MgF₂ | 1.38 | 240.47 |
| 11 | TiO₂ | 2.26 | 50.26 |
| 10 | Al₂O₃ | 1.61 | 144.16 |
| 9 | MgF₂ | 1.38 | 149.64 |
| 8 | TiO₂ | 2.26 | 38.09 |
| 7 | Al₂O₃ | 1.61 | 150.21 |
| 6 | MgF₂ | 1.38 | 59.74 |
| 5 | TiO₂ | 2.26 | 65.77 |
| 4 | Al₂O₃ | 1.61 | 156.66 |
| 3 | MgF₂ | 1.38 | 58.78 |
| 2 | TiO₂ | 2.26 | 41.42 |
| 1 | MgF₂ | 1.38 | 54.79 |
| | Reflected light entering side | 1.64 | |
| | prism (S-TIM22) | | |

Since a wavelength of 685 nm for the laser diode 101 of the present embodiment and an angle of divergence of ±9° for the finite light (divergent light) emitted from the laser diode are used, the multilayer film 13 is formed so that reflectance Rp of P polarized light of reflected light outputted in the prescribed direction (a direction of photodetector 108) from light emitted from the laser diode 101 may satisfy 15%≦Rp<25%, reflectance R′p of P polarized light of reflected light outputted in the prescribed direction (a direction of photodetector 111) from light reflected on magneto-optical disc 107 may satisfy 15%≦R′p<25%, and reflectance Rs of S polarized light of reflected light outputted in the prescribed direction (a direction of photodetector 111) from light reflected on magneto-optical disc 107 may satisfy Rs≧90%, under the conditions of an incident wavelength for prism of 685±25 nm and an angle of incidence of 0±9°. The multilayer film 13 is further formed so that difference of reflection phase Δ between P polarized light and S polarized light may satisfy 170°≦Δ≦190°.

Further, in the case of a polarization beam splitter of a cemented prism type as in the present embodiment, it is utilized that the reflectance of P polarized light becomes 0% at an angle of polarization θB. When nH represents a reflectance of a high reflectance layer, nL represents a reflectance of a low reflectance layer, ng represents a reflectance of a prism material and θg represents an angle of incidence on a surface of prism (surface of multilayer film), the reflectance of P polarized light becomes 0% in the case of angle of incidence θg satisfying the relationship of the following expression 1, which makes it possible to achieve 100% for S polarized light, depending on the number of layers and the refractive index.
sin² (θg)=(nH²×nL²)/(ng²×(nH²+nL²)) Expression 1

In the present embodiment, reflection of P polarized light is needed for detection of power monitor of a light flux emitted from laser diode 101 and for detection of a difference between P polarized light and S polarized light in the reflected light coming from magneto-optical disc 107, therefore, nothing functions when the reflectance of P polarized light is 0%. Further, a quantity of light needed for recording and reproducing for magneto-optical disc 107 is greater than that needed for detection of power monitor. Therefore, there is provided a multilayer film that reflects a part (a range of 10%≦reflectance Rp≦40%, and of 15%≦Rp<25% in the present embodiment as stated above) of P polarized light. With respect to the reflectance of S polarized light, it is needed for detection of a difference between P polarized light and S polarized light in the reflected light coming from magneto-optical disc 107, therefore, the reflectance of S polarized light is formed to be high (Reflectance Rs≧90%). In this case, the reflectance is formed so that a part of the P polarized light of the reflected light coming from the magneto-optical disc 107 may also be reflected (a range of 10%≦reflectance R′p≦40%, and of 15%≦R′p≦25% in the present embodiment as stated above).

Since the aforesaid Expression 1 gives θg=53.1° for nH=2.26, nL=1.61 and ng=1.64, θg=45.9° for nH=2.26, nL=1.38 and ng=1.64, and θg=39.7° for nH=1.61, nL=1.38 and ng=1.64, when TiO₂ (n=2.26) and MgF₂ (n=1.38) only are used, θg=45.9° is given, and it is not possible to enhance the reflectance of P polarized light when angle of incidence θ on the surface of the prism is 45°. Therefore, if Al₂O₃ (n=1.61) is also combined, in addition to TiO₂ and MgF₂, θg=39.7° and θg=53.1° can exist, and the reflectance of P polarized light can be enhanced. Meanwhile, though a lamination structure of two types of layers of TiO₂ (n=2.26) and Al₂O₃ (n=1.61), or a lamination structure of two types of layers of Al₂O₃ (n=1.61) and MgF₂ (n=1.38) works for causing θg≈45° to hold, but a refractive index difference needs to be great for enhancing the reflectance of S polarized light, therefore, desired optical characteristics cannot be obtained by the combination of the two types stated above. Further, if a difference of refractive indexes is large, a broad band for polarization separation can be taken, and wavelength-dependency can be made small accordingly. Therefore, three types of a low refractive index layer, a medium refractive index layer and a high refractive index layer are necessary for the multilayer film.

Further, it may be possible to construct four kind of layers by the use of two kinds of materials differing in refractive index such as MgF2 and SiO2 among the low refractive index layer, also, it may be possible to construct four kind of layers by the use of two kinds of materials differing in refractive index such as TiO2 and Ta2O5 among the high refractive index layer. Likewise, by selecting four kinds or more of layers appropriately, the quality of layer can be improved by relaxation of stress, and reduction of layer scattering.

Meanwhile, in the invention, let it be assumed that a low refractive index layer means a layer wherein refractive index nL is within a range of 1.35≦nL≦1.6, a medium refractive index layer means a layer wherein refractive index nM is within a range of 1.6≦nM≦2.0 and a high refractive index layer means a layer wherein refractive index nH is within a range of 2.0≦nH≦2.6, provided, however, that the refractive index is under the condition of wavelength of 546 nm.

Though the multilayer film 13 in the present embodiment is formed by a vacuum evaporation method, the invention is not limited to this vacuum evaporation method, and other deposition methods such as a sputtering method and CVD can be used for forming. In the present embodiment, as a material for constituting each layer, MgF₂ was used for a low refractive index material constituting the low refractive index layer, Al₂O₃ was used for a medium refractive index material constituting the medium refractive index layer, and TiO₂ was used for a high refractive index material constituting the high refractive index layer. In this case, there is a merit that the number of layers constituting the multilayer film 13 can be reduced, because a difference of refractive indexes between MgF₂ and TiO₂ is as large as 0.88. In addition to these materials, it is also possible to use SiO₂ for a low refractive index material, Y₂O₃, SiO and Si₂O₃ for a medium refractive index material and Ta₂O₅, ZrO₂, Nb₂O₃, CeO₂, CeF₃, HfO₂ and ZrTiO₄ for a high refractive index material, and a design can be worked out so that desired optical characteristics may be obtained in accordance with the refractive index.

A forming method and the structure for the multilayer film 13 of the present embodiment are as follows.

First, after evacuating a vacuum chamber to a level of 1.0×10⁻³ Pa, MgF₂ was formed on the first layer with oxygen gas introduction amount of 5.0×10⁻³ Pa at a deposition rate of 2.5 Å/sec. Next, TiO₂ was formed on the second layer with oxygen gas introduction amount of 1.0×10⁻² Pa at a deposition rate of 3 Å/sec. On the third layer, MgF₂ was formed again, and Al₂O₃ was formed on the fourth layer with oxygen gas introduction amount of 5.0×10⁻³ Pa at a deposition rate of 4 Å/sec and on the fifth layer, TiO₂ was formed again. After that, from the sixth layer to the eleventh layer, MgF₂, Al₂O₃ and TiO₂ were deposited repeatedly in this order, and MgF₂ was deposited on the 12^{th} layer, TiO₂ was deposited on the 13^{th} layer, MgF₂ was deposited on the 14^{th} layer and TiO₂ was deposited on the 15^{th} layer, for forming the multilayer film 13.

As stated above, in the present embodiment, each of the third, fourth and fifth layers is of the specifically laminated portion wherein a low refractive index layer composed of low refractive index material MgF₂, a medium refractive index layer composed of medium refractive index material Al₂O₃ and a high refractive index layer composed of high refractive index material TiO₂, and each of the 6^{th}, 7^{th} and 8^{th} layers is of the specifically laminated portion and each of the 9^{th}, 10^{th} and 11^{th} layers is of the specifically laminated portion. In this way, the 3^{rd} layer up to the 11^{th} layer are represented by plural specifically laminated portions each being deposited with MgF₂, Al₂O₃ and TiO₂ repeatedly, thus, depositing repeatedly in the order of the low refractive index material, medium refractive index material and high refractive index material, results in the multilayer film 13 wherein wavelength-dependency and incident-angle-dependency for reflectance, transmittance and reflection phase difference can be reduced.

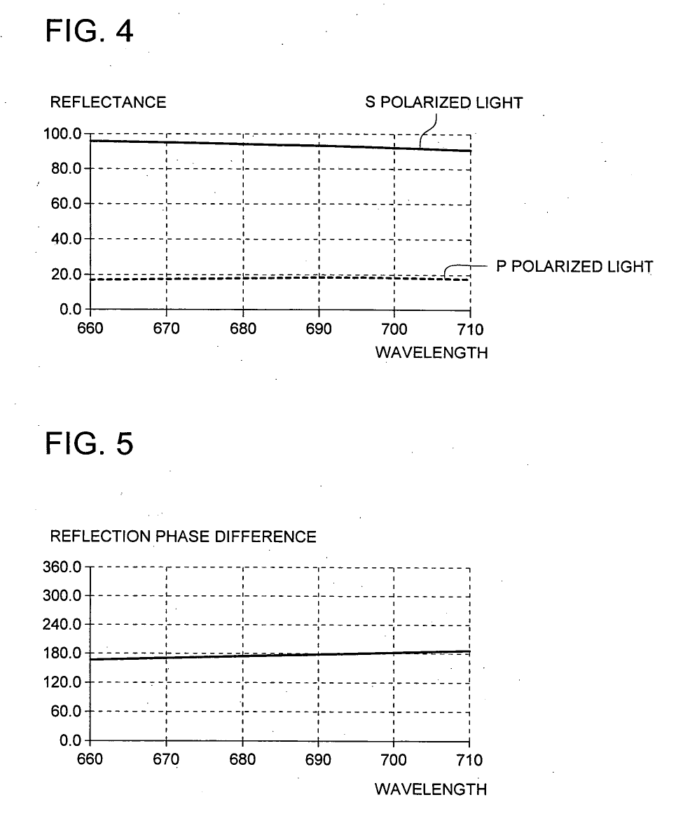

When wavelength-dependency for the reflectance and that for the reflection phase difference for each of S polarized light and P polarized light were measured under the condition of an angle of incidence on the film surface that is 45°, the wavelength-dependency of the reflectance for each of S polarized light and P polarized light proved to be as a graph shown in FIG. 4, and the wavelength-dependency of the reflection phase difference for each of S polarized light and P polarized light proved to be as a graph shown in FIG. 5.

Incidentally, a spectral ellipsometry (made by J.A. Woollam Co., Product name: VASE) was used for measurement for the wavelength-dependency of the reflectance and for that of the reflection phase difference.

The beam splitter 10 prepared was set on a stage for measurement so that it may form 45° with the film surface, then, measurement light having an optional wavelength deflected by reflected light entering side prism 12 was made to enter the beam splitter, and changes and intensity of the state of polarization of light reflected by the beam splitter 10 were detected. With respect to measurement of the reflectance, it is possible to measure even by a spectrophotometer (made by Hitachi, Ltd., Product name: U-4000) by combining polarizers.

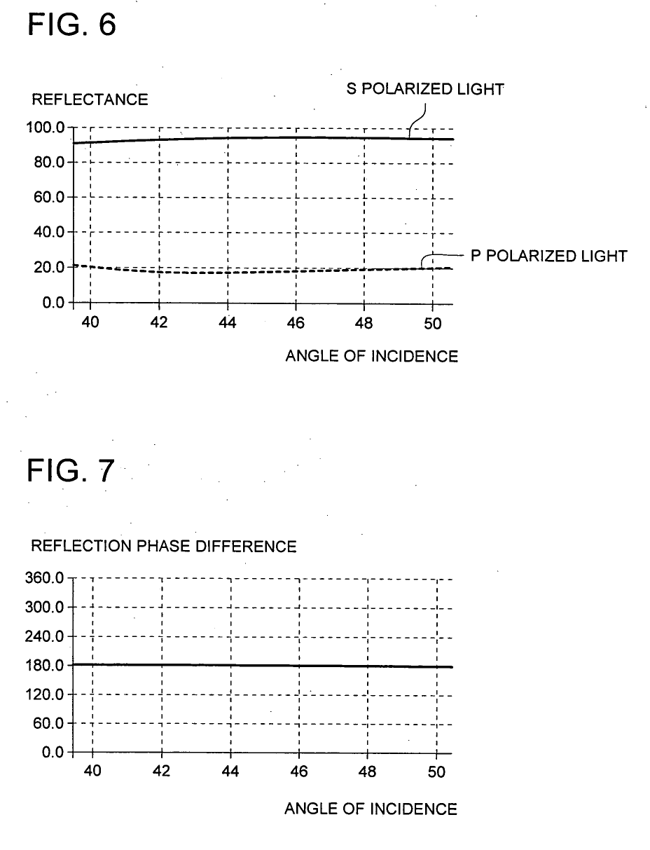

Further, incident-angle-dependency for reflectance and that for reflection phase difference for each of S polarized light and P polarized light were measured under the condition of a wavelength for measurement of 685 nm, and results of the incident-angle-dependency for reflectance for each of S polarized light and P polarized light are shown in FIG. 6, while, results of the incident-angle-dependency for reflection phase difference for each of S polarized light and P polarized light are shown in FIG. 7.

The beam splitter 10 prepared was set on a stage for measurement, then, measurement light with λ=685 nm. deflected by reflected light entering side prism 12 was made to enter the beam splitter, and changes and intensity of the state of polarization of light reflected by the beam splitter 10 were detected. In this case, the reflectance and the reflection phase difference for an optional reflection angle were measured.

Meanwhile, the same measurement as in the foregoing was taken even for reflectance and reflection phase difference of the second, third and fifth embodiments described below. Further, concerning measurement of wavelength-dependency of transmittance for each of S polarized light and P polarized light and measurement of incident-angle-dependency of transmittance for each of S polarized light and P polarized light, illustration and explanation will be omitted in the present embodiment and in the following embodiments, because the wavelength-dependency of reflectance for each of S polarized light and P polarized light and incident-angle-dependency of reflectance for each of S polarized light and P polarized light are two sides of the same coin.

As shown in graphs in FIG. 4-FIG. 7, an angle of incidence represented by the axis of abscissas is an angle of incidence on a prism bonded surface, and when this angle is 45°±5.5°, an angle of incidence on a vertical plane of incidence of the prism becomes 0°±9°. It is understood from these characteristic graphs that the beam splitter 10 is one whose wavelength-dependency for each of reflectance, transmittance and reflection phase difference and incident-angle-dependency for each of reflectance, transmittance and reflection phase difference are small.

If this beam splitter is used in the optical pickup device 100 shown in FIG. 1, excellent recording and reproducing characteristics are obtained.

### Second Embodiment

Next, Second Embodiment to which the invention is applied will be explained.

In the present embodiment, structures of the beam splitter excluding that of a multilayer film are the same as those in the First Embodiment, and therefore, explanation for the similar structures will be omitted.

The multilayer film of the beam splitter relating to the Second Embodiment will be explained below.

Multilayer film 13 in the present embodiment is a coated film provided on a slant of the reflected light entering side prism 12, as in the First Embodiment, and it is formed to be of the structure shown in Table 2.

TABLE 2

| | | Refractive | Layer |
|---|---|---|---|
| No. | | index | thickness (nm) |
| | Illuminant light entering | 1.64 | |
| | side prism (S-TIM22) | | |
| | UV curing adhesive agent | 1.6 | |
| 20 | MgF₂ | 1.38 | 116.58 |
| 19 | Ta₂O₅ | 2.04 | 173.97 |
| 18 | Al₂O₃ | 1.61 | 129.02 |
| 17 | MgF₂ | 1.38 | 172.34 |
| 16 | Ta₂O₅ | 2.04 | 65.21 |
| 15 | Al₂O₃ | 1.61 | 109.35 |
| 14 | MgF₂ | 1.38 | 133.96 |
| 13 | Ta₂O₅ | 2.04 | 65.98 |
| 12 | Al₂O₃ | 1.61 | 128.46 |
| 11 | MgF₂ | 1.38 | 112.18 |
| 10 | Ta₂O₅ | 2.04 | 62.26 |
| 9 | Al₂O₃ | 1.61 | 143.59 |
| 8 | MgF₂ | 1.38 | 72.6 |
| 7 | Ta₂O₅ | 2.04 | 69.89 |
| 6 | Al₂O₃ | 1.61 | 146.69 |
| 5 | Ta₂O₅ | 2.04 | 103.1 |
| 4 | Al₂O₃ | 1.61 | 144.91 |
| 3 | Ta₂O₅ | 2.04 | 47.12 |
| 2 | MgF₂ | 1.38 | 58.24 |
| 1 | Ta₂O₅ | 2.04 | 26.12 |
| | Reflected light entering side | 1.64 | |
| | prism (S-TIM22) | | |

The multilayer film 13 of the present embodiment is formed so that reflectance Rp of P polarized light of reflected light in the case where light from laser diode 101 is outputted in the prescribed direction (the direction of photodetector 108) may satisfy 15%≦Rp≦25%, reflectance R′p of P polarized light of reflected light in the case where light reflected on magneto-optical disc 107 is outputted in the prescribed direction (the direction of photodetector 111) may satisfy 15%≦R′p≦25%, and reflectance Rs of S polarized light of reflected light in the case where light reflected on magneto-optical disc 107 is outputted in the prescribed direction (the direction of photodetector 111) may satisfy Rs≧90%, under the conditions that an incoming wavelength to a prism is 685±25 nm and an angle of incidence is 0±9°, for utilizing wavelength 685 nm of laser diode 101 and divergence angle ±9° of finite light emitted, in the same way as in the First Embodiment. Further, the multilayer film is formed so that reflection phase difference Δ between P polarized light and S polarized light may satisfy 170°≦Δ≦190°.

The multiplayer film 13 of the present embodiment was formed through a vacuum evaporation method in the same way as in the First Embodiment. However, the invention is not limited only to this, and other deposition methods such as a sputtering method and CVD can be used for forming. In the present embodiment, as a material for constituting each layer, MgF₂ was used for a low refractive index material constituting the low refractive index layer, Al₂O₃ was used for a medium refractive index material constituting the medium refractive index layer, and Ta₂O₅ was used for a high refractive index material constituting the high refractive index layer. In this case, it is possible to lighten the stress of the whole layers by laminating respective layers having respectively MgF₂ and Al₂O₃ each having tensile stress and a layer of Ta₂O₃ having compression stress, and thereby, to achieve a multilayer film excellent in terms of environmental resistance on which peeling and cracks are hardly caused. In addition to these, it is also possible to use SiO₂ for a low refractive index material, Y₂O₃, SiO and Si₂O₃ for a medium refractive index material and TiO₂, ZrO₂, Nb₂O₃, CeO₂, CeF₃, HfO₂ and ZrTiO₄ for a high refractive index material, and a design can be worked out so that desired optical characteristics may be obtained in accordance with the refractive index.

A forming method and the structure for the multilayer film 13 of the present embodiment are as follows.

First, after evacuating a vacuum chamber to a level of 1.0×10⁻³ Pa, Ta₂O₅ was formed on the first layer with oxygen gas introduction amount of 1.0×10⁻² Pa at a deposition rate of 3 Å/sec. Next, MgF₂ was formed on the second layer with oxygen gas introduction amount of 5.0×10⁻³ Pa at a deposition rate of 2.5 Å/sec. On the third layer, Ta₂O₅ was formed again, and Al₂O₃ was formed on the fourth layer with oxygen gas introduction amount of 5.0×10⁻³ Pa at a deposition rate of 4 Å/sec, Ta₂O₅ was formed on the fifth layer, Al₂O₃ was formed on the sixth layer and Ta₂O₅ was formed on the 7^{th} layer. After that, from the 8^{th} layer to the 19^{th} layer, MgF₂, Al₂O₃ and Ta₂O₅ were deposited repeatedly in this order, and MgF₂ was deposited on the 20^{th} layer, for forming the multilayer film 13.

As stated above, in the present embodiment, each of the 8^{th} layer to the 10^{th} layer is the specific laminated portion wherein a low refractive index layer made of low refractive index material MgF₂, a medium refractive index layer made of medium refractive index material Al₂O₃ and high refractive index layer made of high refractive index material Ta₂O₅ are laminated, in this order from the reflected light entering side, and in the same way, each of the 11^{th} layer to the 13^{th}, each of the 14^{th} layer to the 16^{th} layer and each of the 17^{th} layer to the 19^{th} layer also represent the specific laminated portion respectively. As stated above, each of 8^{th}-19^{th} layers represents a plurality of specific laminated portions wherein MgF₂, Al₂O₃ and Ta₂O₅ are repeatedly deposited in this order, and a low refractive index layer, a medium refractive index layer and a high refractive index layer are repeated in this order, resulting in multilayer film 13 wherein wavelength-dependency of reflectance, transmittance and reflection phase difference and incident-angle-dependency of reflectance, transmittance and of reflection phase difference of a beam splitter, can be made small.

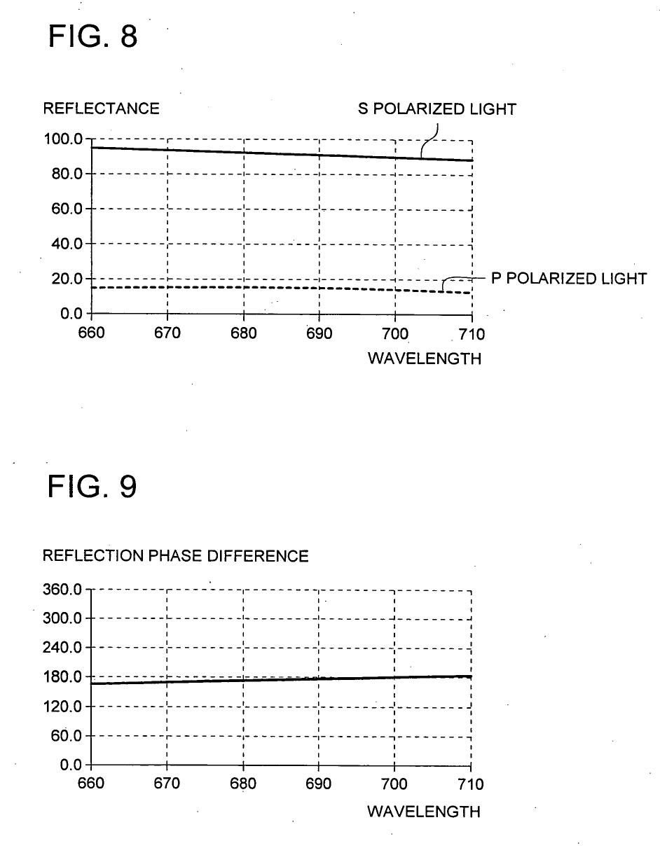

When wavelength-dependency for the reflectance and that for the reflection phase difference for each of S polarized light and P polarized light were measured under the condition of an angle of incidence on the film surface that is 45°, the wavelength-dependency of the reflectance for each of S polarized light and P polarized light proved to be as a graph shown in FIG. 8, and the wavelength-dependency of the reflection phase difference for each of S polarized light and P polarized light proved to be as a graph shown in FIG. 9.

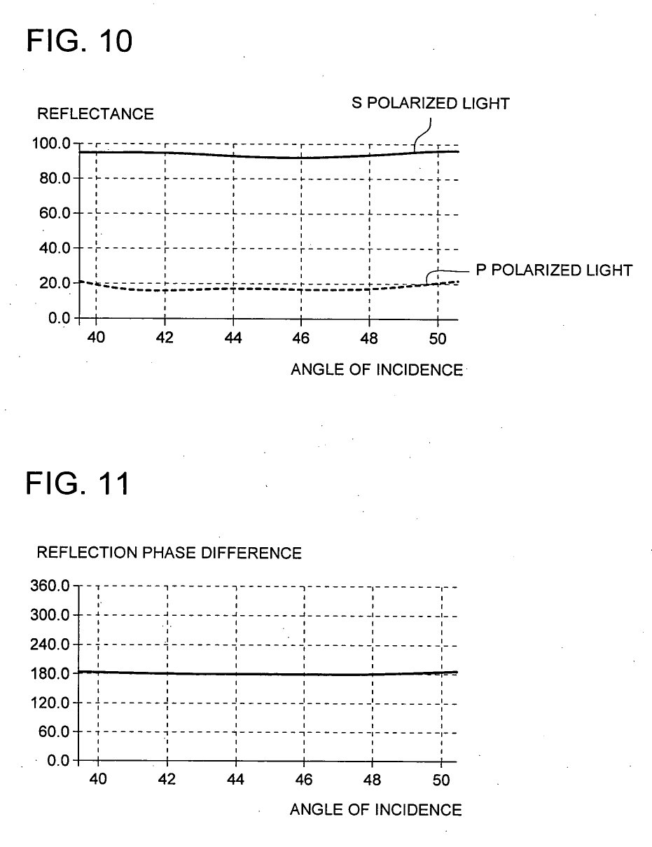

Further, incident-angle-dependency for reflectance and that for reflection phase difference for each of S polarized light and P polarized light were measured under the condition of a wavelength for measurement of 685 nm, and results of the incident-angle-dependency for reflectance for each of S polarized light and P polarized light are shown in FIG. 10, while, results of the incident-angle-dependency for reflection phase difference for each of S polarized light and P polarized light are shown in FIG. 11.

As shown in graphs in FIG. 8-FIG. 11, an angle of incidence represented by the axis of abscissas is an angle of incidence on a prism bonded surface, and when this angle is 45°±5.5°, an angle of incidence on a vertical plane of incidence of the prism becomes 0°±9°. It is understood from these characteristic graphs that the beam splitter 10 is one whose wavelength-dependency for each of reflectance, transmittance and reflection phase difference and incident-angle-dependency for each of reflectance, transmittance and reflection phase difference are small.

If this beam splitter is used in the optical pickup device 100 shown in FIG. 1, excellent recording and reproducing characteristics are obtained.

### Third Embodiment

Next, Third Embodiment to which the invention is applied will be explained.

In the present embodiment, structures of the beam splitter excluding that of a multilayer film are the same as those in the First Embodiment, and therefore, explanation for the similar structures will be omitted.

The multilayer film of the beam splitter relating to the Third Embodiment will be explained below.

Multilayer film 13 in the present embodiment is a coated film provided on a slant of the reflected light entering side prism 12, as in the First Embodiment, and it is formed to be of the structure shown in Table 3.

TABLE 3

| | | Refractive | Layer |
|---|---|---|---|
| No. | | index | thickness (nm) |
| | Illuminant light entering | 1.64 | |
| | side prism (S-TIM22) | | |
| | UV curing adhesive agent | 1.6 | |
| 22 | SiO₂ | 1.45 | 187.57 |
| 21 | TiO₂ | 2.26 | 23.68 |
| 20 | SiO₂ | 1.45 | 94.15 |
| 19 | Al₂O₃ | 1.61 | 116.03 |
| 18 | TiO₂ | 2.26 | 26.84 |
| 17 | SiO₂ | 1.45 | 156.3 |
| 16 | TiO₂ | 2.26 | 44.87 |
| 15 | Al₂O₃ | 1.61 | 120.77 |
| 14 | SiO₂ | 1.45 | 112.41 |
| 13 | TiO₂ | 2.26 | 51.25 |
| 12 | Al₂O₃ | 1.61 | 144.21 |
| 11 | SiO₂ | 1.45 | 60.74 |
| 10 | TiO₂ | 2.26 | 70.94 |
| 9 | Al₂O₃ | 1.61 | 137.86 |
| 8 | SiO₂ | 1.45 | 49.38 |
| 7 | TiO₂ | 2.26 | 79.86 |
| 6 | Al₂O₃ | 1.61 | 156.61 |
| 5 | SiO₂ | 1.45 | 221.15 |
| 4 | Al₂O₃ | 1.61 | 166.72 |
| 3 | TiO₂ | 2.26 | 58.61 |
| 2 | SiO₂ | 1.45 | 43.24 |
| 1 | TiO₂ | 2.26 | 24.56 |
| | Reflected light entering side | 1.64 | |
| | prism (S-TIM22) | | |

The multilayer film 13 of the present embodiment is formed so that reflectance Rp of P polarized light of reflected light in the case where light from laser diode 101 is outputted in the prescribed direction (the direction of photodetector 108) may satisfy 15%≦Rp≦25%, reflectance R′p of P polarized light of reflected light in the case where light reflected on magneto-optical disc 107 is outputted in the prescribed direction (the direction of photodetector 111) may satisfy 15%≦R′p≦25%, and reflectance Rs of S polarized light of reflected light in the case where light reflected on magneto-optical disc 107 is outputted in the prescribed direction (the direction of photodetector 111) may satisfy Rs≧90%, under the conditions that an incoming wavelength to a prism is 685±25 nm and an angle of incidence is 0±9°, for utilizing wavelength 685 nm of laser diode 101 and divergence angle±9° of finite light (divergent light) emitted, in the same way as in the First Embodiment. Further, the multilayer film is formed so that reflection phase difference Δ between P polarized light and S polarized light may satisfy 170°≦Δ≦190°.

The multiplayer film 13 of the present embodiment was formed through a vacuum evaporation method in the same way as in the First Embodiment. However, the invention is not limited only to this, and other deposition methods such as a sputtering method and CVD can be used for forming. In the present embodiment, as a material for constituting each layer, SiO₂ was used for a low refractive index material constituting the low refractive index layer, Al₂O₃ was used for a medium refractive index material constituting the medium refractive index layer, and TiO₂ was used for a high refractive index material constituting the high refractive index layer. In this case, it is possible to lighten the stress of the whole layers by laminating respective layers including a layer of SiO₂ having compression stress and respective layers of Al₂O₃ and TiO₂ each having tensile stress and thereby, to achieve a multilayer film excellent in terms of environmental resistance on which peeling and cracks are hardly caused. In addition to these, it is also possible to use MgF₂ for a low refractive index material, Y₂O₃, SiO and Si₂O₃ for a medium refractive index material and Ta₂O₅, ZrO₂, Nb₂O₃, CeO₂, CeF₃, HfO₂ and ZrTiO₄ for a high refractive index material, and a design can be worked out so that desired optical characteristics may be obtained in accordance with the refractive index.

A forming method and the structure for the multilayer film 13 of the present embodiment are as follows.

First, after evacuating a vacuum chamber to a level of 1.0×10⁻³ Pa, TiO₂ was formed on the first layer with oxygen gas introduction amount of 5.0×10⁻³ Pa at a deposition rate of 3 Å/sec. Next, SiO₂ was formed on the second layer with oxygen gas introduction amount of 1.0×10⁻² Pa at a deposition rate of 8 Å/sec. On the third layer, TiO₂ was formed again, and Al₂O₃ was formed on the fourth layer with oxygen gas introduction amount of 5.0×10⁻³ Pa at a deposition rate of 4 Å/sec. After that, for each of the 5^{th} layer to the 16^{th} layer, SiO₂, Al₂O₃ and TiO₂ were deposited repeatedly in this order, then, SiO₂ was deposited on the 17^{th} layer, TiO₂ was deposited on the 18^{th} layer, Al₂O₃ was deposited on the 19^{th} layer, SiO₂ was deposited on the 20^{th} layer, TiO₂ was deposited on the 21^{st} layer, and SiO₂ was deposited on the 22^{nd} layer, to make multilayer film 13.

As stated above, in the present embodiment, each of the 5^{th} layer to the 7^{th} layer is the specific laminated portion wherein a low refractive index layer made of low refractive index material SiO₂, a medium refractive index layer made of medium refractive index material Al₂O₃ and high refractive index layer made of high refractive index material TiO₂ are laminated, in this order from the reflected light entering side, and in the same way, each of the 8^{th} layer to the 10^{th}, each of the 11^{th} layer to the 13^{th} layer and each of the 14^{th} layer to the 16^{th} layer also represent the specific laminated portion respectively. As stated above, each of 5^{th}-16^{th} layers represents a plurality of specific laminated portions wherein SiO₂, Al₂O₃ and TiO₂ are repeatedly deposited in this order, and a low refractive index layer, a medium refractive index layer and a high refractive index layer are repeated in this order, resulting in multilayer film 13 wherein wavelength-dependency of reflectance, transmittance and reflection phase difference and incident-angle-dependency of reflectance, transmittance and of reflection phase difference of a beam splitter, can be made small.

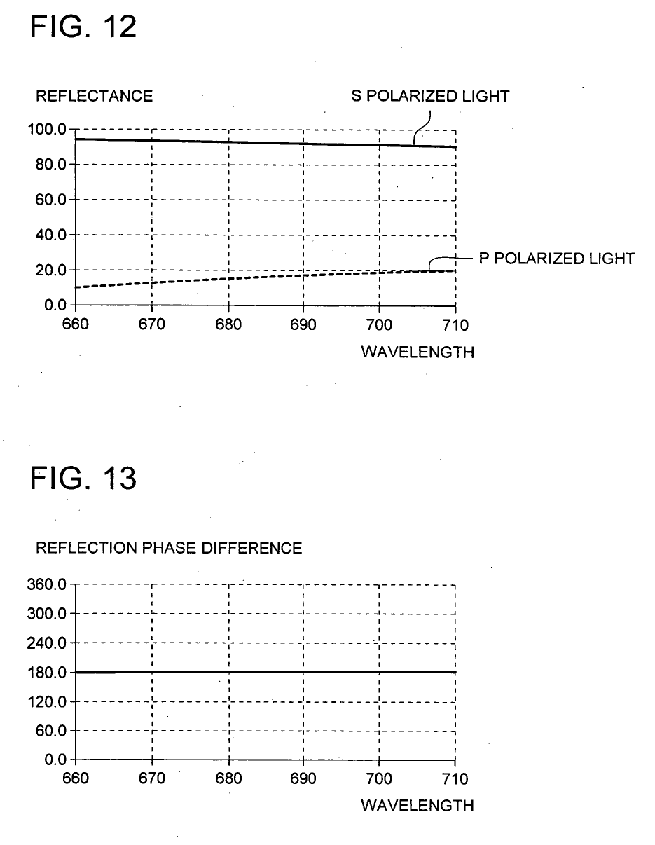

When wavelength-dependency for the reflectance and that for the reflection phase difference for each of S polarized light and P polarized light were measured under the condition of an angle of incidence on the film surface that is 45°, the wavelength-dependency of the reflectance for each of S polarized light and P polarized light proved to be as a graph shown in FIG. 12, and the wavelength-dependency of the reflection phase difference for each of S polarized light and P polarized light proved to be as a graph shown in FIG. 13.

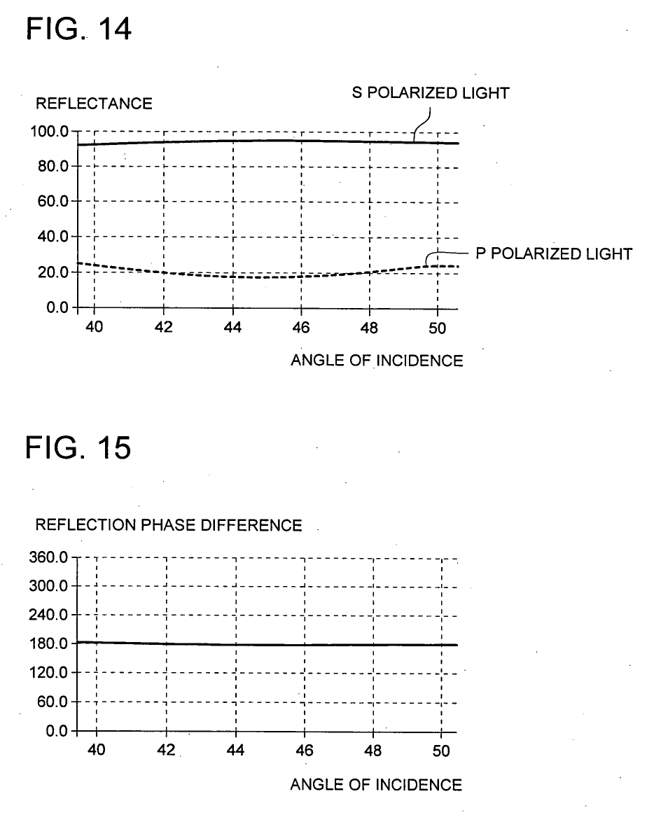

Further, incident-angle-dependency for reflectance and that for reflection phase difference for each of S polarized light and P polarized light were measured under the condition of a wavelength for measurement of 685 nm, and results of the incident-angle-dependency for reflectance for each of S polarized light and P polarized light are shown in FIG. 14, while, results of the incident-angle-dependency for reflection phase difference for each of S polarized light and P polarized light are shown in FIG. 15.

As shown in graphs in FIG. 12-FIG. 15, an angle of incidence represented by the axis of abscissas is an angle of incidence on a prism bonded surface, and when this angle is 45°±5.5°, an angle of incidence on a vertical plane of incidence of the prism becomes 0±9°. It is understood from these characteristic graphs that the beam splitter 10 is one whose wavelength-dependency for each of reflectance, transmittance and reflection phase difference and incident-angle-dependency for each of reflectance, transmittance and reflection phase difference are small.

If this beam splitter is used in the optical pickup device 100 shown in FIG. 1, excellent recording and reproducing characteristics are obtained.

### Fourth Embodiment

Next, Fourth Embodiment to which the invention is applied will be explained.

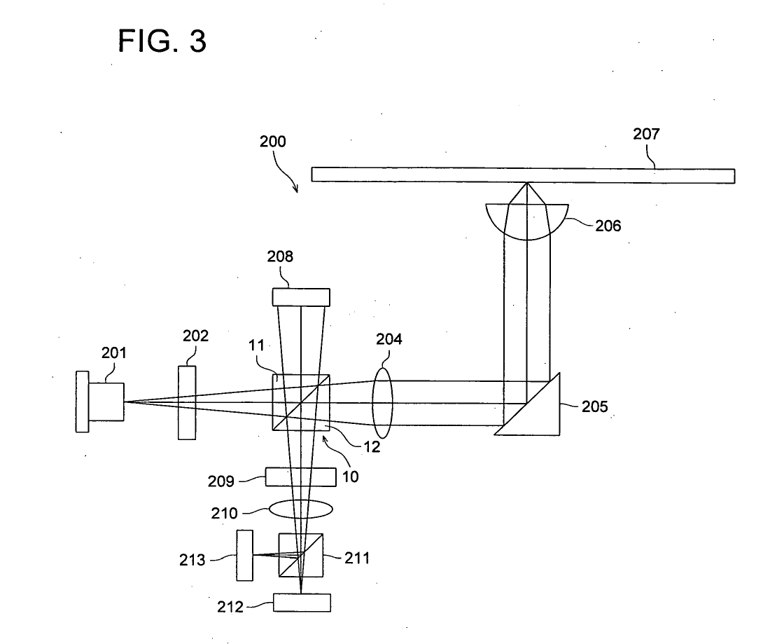

FIG. 3 is a diagram showing schematically optical pickup device 200 relating to Fourth Embodiment to which the invention is applied.

The optical pickup device 200 of the present embodiment is provided with laser diode 201 representing a light source, diffraction plate 202, beam splitter 10 composed of illuminant light entering side prism 11 and reflected light entering side prism 12 in the same way as in First Embodiment, collimator lens 204, laser mirror 205, objective lens 206, magneto-optical disc 207 representing an information recording medium, photodetector 208, a wavelength plate 209, cylindrical lens 210, polarization beam splitter 211 and with photodectors 211 and 213.

An occasion to reproduce information recorded on the magneto-optical disc 207 will be explained next.

A plane of vibration of the electric field of the linearly polarized light emitted from laser diode 201 is established to be in parallel with a plane of incidence of the illuminant light entering side prism 11 of the beam splitter 10. After the linearly polarized light emitted from laser diode 201 passes through the diffraction plate 202, a reflected light of a part of the linearly polarized light enters the photodetector 208, and the rest of transmitted light is converged on the magneto-optical disc 207 through the collimator lens 204, the laser mirror 205 and the objective lens 206.

Light reflected on the magneto-optical disc 207 is subjected to Kerr rotation in the direction of magnetization, then its plane of vibration is rotated slightly, and enters the beam splitter 10 again through the objective lens 206, the laser mirror 205 and the collimator lens 204. While, incident light coming from the laser diode 201 is P polarized light, returning light (reflected light) from the magneto-optical disc is divided into P polarized light component and S polarized light component because the returning light is subjected to Kerr rotation, then, a fixed amount of light for each of P polarized light component and S polarized light component is reflected by the beam splitter 10, thus, the P polarized light component and S polarized light component pass through a wavelength plate 209, and cylindrical lens 210, to be separated by polarization beam splitter 211 into P polarized light component and S polarized light component, to enter respectively photodector 212 and photodector 213. Incidentally, in beam splitter 10, a reflection phase difference of a light flux entering from reflected light entering side prism 12 is set to 180°, and a transmission phase difference of a wavelength plate is set to 180° (half wavelength plate), which results in the structure wherein a difference between P polarized light and S polarized light can be detected.

Meanwhile, the beam splitter in the present embodiment is the same as that in the First Embodiment, and therefore, an explanation will be omitted.

### Fifth Embodiment

Next, Fifth Embodiment to which the invention is applied will be explained.

In the optical pickup device of the present embodiment, an arrangement of the optical element is the same as that in the Fourth Embodiment, but, a phase difference between the beam splitter and the wavelength plate is different. In the beam splitter, a reflection phase difference of a light flux entering from the reflected light entering side prism is set to 90°, and a transmission phase difference of the wavelength plate is set to 90° (quarter wavelength plate), which results in the structure wherein a difference between P polarized light and S polarized light can be detected.

A multilayer film of the beam splitter relating to the Fifth Embodiment will be explained as follows.

Multilayer film 13 in the present embodiment is a coated film provided on a slant of the reflected light entering side prism 12, as in the First Embodiment, and it is formed to be of the structure shown in Table 4.

TABLE 4

| | | Refractive | Layer |
|---|---|---|---|
| No. | | index | thickness (nm) |
| | Illuminant light entering | 1.64 | |
| | side prism (S-TIM22) | | |
| | UV curing adhesive agent | 1.6 | |
| 16 | MgF₂ | 1.38 | 159.71 |
| 15 | TiO₂ | 2.26 | 27.6 |
| 14 | Al₂O₃ | 1.61 | 42.99 |
| 13 | MgF₂ | 1.38 | 202.96 |
| 12 | TiO₂ | 2.26 | 64.02 |
| 11 | Al₂O₃ | 1.61 | 87.6 |
| 10 | MgF₂ | 1.38 | 144.59 |
| 9 | TiO₂ | 2.26 | 65.84 |
| 8 | Al₂O₃ | 1.61 | 96.28 |
| 7 | MgF₂ | 1.38 | 193.08 |
| 6 | TiO₂ | 2.26 | 38.49 |
| 5 | Al₂O₃ | 1.61 | 144.1 |
| 4 | MgF₂ | 1.38 | 155.47 |
| 3 | TiO₂ | 2.26 | 32.17 |
| 2 | Al₂O₃ | 1.61 | 133.72 |
| 1 | MgF₂ | 1.38 | 127.26 |
| | Reflected light entering side | 1.64 | |
| | prism (S-TIM22) | | |

The multilayer film 13 of the present embodiment is formed so that reflectance Rp of P polarized light of reflected light in the case where light from laser diode 101 is outputted in the prescribed direction (the direction of photodetector 108) may satisfy 15%≦Rp≦25%, reflectance R′p of P polarized light of reflected light in the case where light reflected on magneto-optical disc 107 is outputted in the prescribed direction (the direction of photodetector 111) may satisfy 15%≦R′p≦25%, and reflectance Rs of S polarized light of reflected light in the case where light reflected on magneto-optical disc 107 is outputted in the prescribed direction (the direction of photodetector 111) may satisfy Rs≧90%, under the conditions that an incoming wavelength to a prism is 685±25 nm and an angle of incidence is 0±9°, for utilizing wavelength 685 nm of laser diode 101 and divergence angle±9° of finite light (divergent light) emitted. Further, the multilayer film is formed so that reflection phase difference Δ between P polarized light and S polarized light may satisfy 170°≦Δ≦190°.

The multiplayer film 13 of the present embodiment was formed through a vacuum evaporation method in the same way as in the First Embodiment. However, the invention is not limited only to this, and other deposition methods such as a sputtering method and CVD can be used for forming. In the present embodiment, as a material for constituting each layer, MgF₂ was used for a low refractive index material constituting the low refractive index layer, Al₂O₃ was used for a medium refractive index material constituting the medium refractive index layer, and TiO₂ was used for a high refractive index material constituting the high refractive index layer. In this case, there is a merit that the number of layers constituting the multiplayer film 13 can be reduced, because a difference of refractive index between MgF₂ and TiO₂ is as large as 0.88. In addition to these, it is also possible to use SiO₂ for a low refractive index material, Y₂O₃, SiO and Si₂O₃ for a medium refractive index material and Ta₂O₅, ZrO₂, Nb₂O₃, CeO₂, CeF₃, HfO₂ and ZrTiO₄ for a high refractive index material, and a design can be worked out so that desired optical characteristics may be obtained in accordance with the refractive index.

A forming method and the structure for the multilayer film 13 of the present embodiment are as follows.

First, after evacuating a vacuum chamber to a level of 1.0×10⁻³ Pa, MgF₂ was formed on the first layer with oxygen gas introduction amount of 5.0×10⁻³ Pa at a deposition rate of 2.5 Å/sec. Next, Al₂O₃ was formed on the second layer with oxygen gas introduction amount of 5.0×10⁻³ Pa at a deposition rate of 4 Å/sec. On the third layer, TiO₂ was formed with oxygen gas introduction amount of 1.0×10⁻² Pa at a deposition rate of 3 Å/sec. After that, from the 4^{th} layer to the 15^{th} layer, MgF₂, Al₂O₃ and TiO₂ were deposited repeatedly in this order, and MgF₂ was deposited on the 16^{th} layer, for forming the multilayer film 13.

As stated above, in the present embodiment, each of the 1^{st} layer to the 3^{rd} layer is the specific laminated portion wherein a low refractive index layer made of low refractive. index material MgF₂, a medium refractive index layer made of medium refractive index material Al₂O₃ and high refractive index layer made of high refractive index material TiO₂ are laminated, in this order from the reflected light entering side, and in the same way, each of the 4^{th} layer to the 6^{th}, each of the 7^{th} layer to the 9^{th} layer, each of the 10^{th} layer to the 12^{th} layer and each of the 13^{th} layer to the 15^{th} layer also represent the specific laminated portion respectively. As stated above, each of 1^{st}-15^{th} layers represents a plurality of specific laminated portions wherein MgF₂, Al₂O₃ and TiO₂ are repeatedly deposited in this order, and a low refractive index layer, a medium refractive index layer and a high refractive index layer are repeated in this order, resulting in multilayer film 13 wherein wavelength-dependency of reflectance, transmittance and reflection phase difference and incident-angle-dependency of reflectance, transmittance and of reflection phase difference of a beam splitter, can be made small.

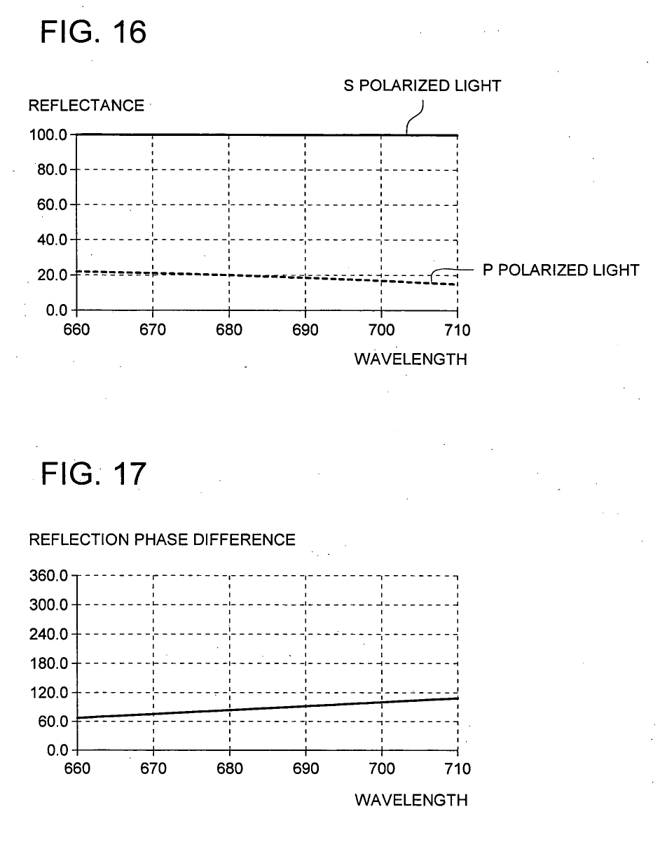

When wavelength-dependency for the reflectance and that for the reflection phase difference for each of S polarized light and P polarized light were measured under the condition of an angle of incidence on the film surface that is 45°, the wavelength-dependency of the reflectance for each of S polarized light and P polarized light proved to be as a graph shown in FIG. 16, and the wavelength-dependency of the reflection phase difference for each of S polarized light and P polarized light proved to be as a graph shown in FIG. 17.

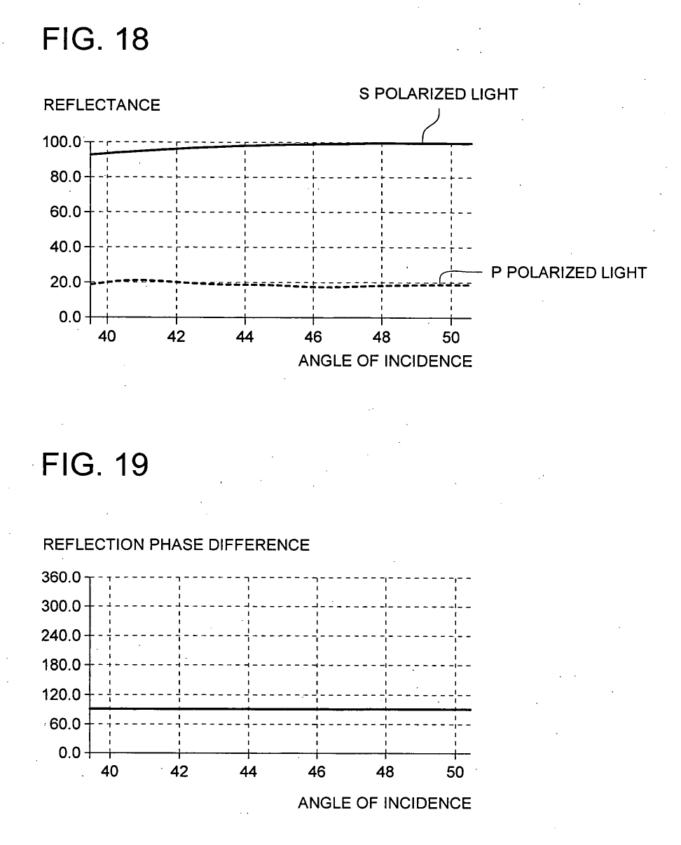

Further, incident-angle-dependency for reflectance and that for reflection phase difference for each of S polarized light and P polarized light were measured under the condition of a wavelength for measurement of 685 nm, and results of the incident-angle-dependency for reflectance for each of S polarized light and P polarized light are shown in FIG. 18, while, results of the incident-angle-dependency for reflection phase difference for each of S polarized light and P polarized light are shown in FIG. 19.

As shown in graphs in FIG. 16-FIG. 19, an angle of incidence represented by the axis of abscissas is an angle of incidence on a prism bonded surface, and when this angle is 45°±5.5°, an angle of incidence on a vertical plane of incidence of the prism becomes 0°±9°. It is understood from these characteristic graphs that the beam splitter 10 is one whose wavelength-dependency for each of reflectance, transmittance and reflection phase difference and incident-angle-dependency for each of reflectance, transmittance and reflection phase difference are small.

If this beam splitter is used in the optical pickup device 200 shown in FIG. 3, excellent recording and reproducing characteristics are obtained.

Incidentally, with respect to the wavelength to be used, although a laser with a wavelength of λ=685 nm is used in the respective embodiments stated above, lasers with other wavelengths may also be used. A layer thickness corresponding to the wavelength to be used may be established, and when using a laser with a wavelength of λ=405 nm, for example, it is possible to laminate a layer thickness obtained by multiplying the layer thickness of each layer in the respective embodiments by 0.59 (405÷685=0.59).

Further, though the optical pickup device employing only one wavelength has been explained in the respective embodiments mentioned above, the invention can also be applied to an optical pickup device using plural wavelengths, by adjusting an optical system and design of a layer.

In the beam splitter in each embodiment of the invention, an illuminant light entering side prism where light emitted from the light source enters and a reflected light entering side prism where light reflected on an information recording medium enters are provided, as stated above, and a multilayer film having plural specific laminated portions each having thereon a low refractive index layer, a medium refractive index layer, and a high refractive index layer, in this order from the reflected light entering side, is provided between the illuminant light entering side prism and the reflected light entering side prism, therefore, it is possible to make wavelength-dependency for reflectance, transmittance and reflection phase difference and incident-angle-dependency for reflectance, transmittance and for reflection phase difference of a beam splitter to be small.

Further, in each embodiment of the invention, reflectance Rs of S polarized light of the reflected light resulted from the light which is reflected on an information recording medium and enters to be outputted in the prescribed direction, satisfies Rs≧90%, reflectance Rp of P polarized light of the reflected light resulted from the light which is emitted from the light source and enters to be outputted in the prescribed direction, satisfies 10%≦Rp≦40%, and reflectance R′p of P polarized light of the reflected light resulted from the light which is reflected on an information recording medium and enters to be outputted in the prescribed direction, satisfies 10%≦R′p≦40%, whereby, it is possible to cause P polarized light in an appropriate amount of light and S polarized light in a large amount of light to be reflected.

In addition, in each embodiment of the invention, a material whose main component is MgF₂ or SiO₂ is used for the low refractive index layer, a material whose main component is any one of Al₂O₃, Y₂O₃, SiO₂ and Si₂O₃ is used for the medium refractive index layer, and a material whose main component is any one of TiO₂, Ta₂O₅, ZrO₂, Nb₂O₃, CeO₂, CeF₃, HfO₂ and ZrTiO₄ is used for the high refractive index layer, which makes it possible to employ the structure wherein wavelength-dependency for reflectance, transmittance and reflection phase difference and incident-angle-dependency for reflectance, transmittance and reflection phase difference of a beam splitter can be made small specifically.

Further, in the First Embodiment, a material whose main component is MgF₂ is used for the low refractive index layer, a material whose main component is Al₂O₃ is used for the medium refractive index layer and a material whose main component is TiO₂ is used for the high refractive index layer, thus, it is possible to make a difference of refractive index between the low refractive index layer and the high refractive index layer to be large. Specifically, when the low refractive index layer and the high refractive index layer are constituted respectively with MgF₂ and TiO₂, a difference of refractive index can be made to be as great as 0.88, whereby, the number of layers constituting the multilayer can be reduced, which is a merit.

Further, in the Second Embodiment, a material whose main component is MgF₂ is used for the low refractive index layer, a material whose main component is Al₂O₃ is used for the medium refractive index layer and a material whose main component is Ta₂O₅ is used for the high refractive index layer, thus, it is possible to lighten the stress of the whole layers by laminating respective layers having respectively MgF₂ and Al₂O₃ each having tensile stress and a layer having a main component of Ta₂O₃ having compression stress, and thereby, to achieve a multilayer film excellent in terms of environmental resistance on which peeling and cracks are hardly caused.

Further, in the Third Embodiment, a material whose main component is SiO₂ is used for the low refractive index layer, a material whose main component is Al₂O₃ is used for the medium refractive index layer and a material whose main component is TiO₂ is used for the high refractive index layer, thus, it is possible to lighten the stress of the whole layers by laminating a layer having a main component of SiO₂ having compression stress and respective layers having respectively Al₂O₃ and TiO₂ each having tensile stress, and thereby, to achieve a multilayer film excellent in terms of environmental resistance on which peeling and cracks are hardly caused.

Furthermore, in each embodiment, a difference of refractive index between an adhesive used for cementing of the illuminant light entering side prism, the multilayer film and the reflected light entering side prism and the reflected light entering side prism is not more than 0.1, therefore, when two prisms are cemented together by adhesives, deterioration of wavefront aberration is less, and efficiency percentage of beam splitters can be improved, even when a certain wedge angle of an adhesion layer is caused by uneven thickness of the adhesion layer.

In the First-Fourth Embodiments, reflection phase difference Δ between S polarized light and P polarized light satisfies −10°≦Δ≦10° or 170°≦Δ≦190°, therefore, an angle of Kerr rotation for a magneto-optical recording medium can be detected accurately, and excellent recording and reproducing characteristics can be obtained.

In the Fifth Embodiment, reflection phase difference Δ between S polarized light and P polarized light satisfies 80°≦Δ≦100° or 260°≦Δ≦280°, therefore, an angle of Kerr rotation for a magneto-optical recording medium can be detected accurately, and excellent recording and reproducing characteristics can be obtained.

In the optical pickup device in each embodiment of the invention, the beam splitter in the aforesaid embodiment is provided, whereby, excellent recording and reproducing characteristics can be obtained.

In the Fifth Embodiment, excellent recording and reproducing characteristics are obtained, and cost can be controlled, because the optical pickup device is provided with a beam splitter described in the Fifth Embodiment and with a half wavelength plate.

Further, excellent recording and reproducing characteristics are obtained, and cost can be controlled, because the optical pickup device is provided with a beam splitter described in the embodiment and with a quarter wavelength plate.

Furthermore, in each embodiment, excellent recording and reproducing characteristics are obtained, and the optical pickup device can be made small, because divergent light emitted from the light source enters the beam splitter.

Owing to this, an apparatus equipped with the optical pickup device can be miniaturized while it keeps having an excellent performance, in each embodiment.

Incidentally, the present invention is not limited to the embodiments stated above, and various improvements and design changes may be made without departing from the spirit and scope of the invention.

What is claimed is:

1. A beam splitter, comprising:
a light source light entering side prism to which a light from a light source enters;
a reflected light entering side prism to which a reflected light from an information recording medium enters;
a multi layer film provided between the light source light entering side prism and the reflected light entering side prism, wherein the multi layer film comprises a plurality of specific laminated sections each of which comprises a low refractive index layer, a medium refractive index layer, and a high refractive index layer in this order from the reflected light entering side.

2. The beam splitter of claim 1, wherein when light reflected on the information recording medium enters the beam splitter, a reflectance Rs of S-polarized light of the reflected light outputted from the beam splitter in a prescribed direction satisfies Rs≧90%, wherein when light from the light source enters the beam splitter, a reflectance Rp of P-polarized light of the reflected light outputted from the beam splitter in a prescribed direction satisfies 10% ≦Rp≦40%, and wherein when light reflected on the information recording medium enters the beam splitter, a reflectance R′p of P polarized light of the reflected light outputted from the beam splitter in a prescribed direction respectively satisfies 10%≦R′p≦40%.

3. The beam splitter of claim 2, wherein the following formulas are satisfied:
Rs≧90%, 15%≦Rp≦25%, and 15%≦R′p≦25%.

4. The beam splitter of claim 1, wherein a material whose main component is MgF₂ or SiO₂ is used for the low refractive index layer, a material whose main component is any one of Al₂O₃, Y₂O₃, SiO₂ and Si₂O₃ is used for the medium refractive index layer, and a material whose main component is any one of TiO₂, Ta₂O₅, ZrO₂, Nb₂O₃, CeO₂, CeF₃, HfO₂ and ZrTiO₄ is used for the high refractive index layer.

5. The beam splitter of claim 4, wherein a material whose main component is MgF₂ is used for the low refractive index layer, a material whose main component is Al₂O₃ is used for the medium refractive index layer, and a material whose main component is TiO₂ is used for the high refractive index layer.

6. The beam splitter of claim 4, wherein a material whose main component is MgF₂ is used for the low refractive index layer, a material whose main component is Al₂O₃ is used for the medium refractive index layer, and a material whose main component is Ta₂O₅ is used for the high refractive index layer.

7. The beam splitter of claim 4, wherein a material whose main component is SiO₂ is used for the low refractive index layer, a material whose main component is Al₂O₃ is used for the medium refractive index layer, and a material whose main component is TiO₂ is used for the high refractive index layer.

8. The beam splitter of claim 1, wherein a difference of refractive index between a refractive index of an adhesive used for cementing the light source light entering side prism, the multi layer film and the reflected light entering side prism and a refractive index of the reflected light entering side prism is 0.1 or less.

9. The beam splitter of claim 8, wherein the difference of refractive index is 0.05 or less.

10. The beam splitter of claim 1, wherein a reflection phase difference Δ between the S-polarized light and the P-polarized light satisfies −10°≦Δ≦10° or 170°≦Δ≦190°.

11. The beam splitter of claim 10, wherein the reflection phase difference Δ satisfies −6°≦Δ≦6° or 174°≦Δ≦186°.

12. The beam splitter of claim 1, wherein a reflection phase difference Δ between the S-polarized light and the P-polarized light satisfies 80°≦Δ≦100° or 260°≦Δ≦280°.

13. The beam splitter of claim 12, wherein the reflection phase difference Δ satisfies 84°≦Δ≦96° or 264°≦Δ≦276°.

14. An optical pickup apparatus, comprising:
the beam splitter described in claim 1.

15. An optical pickup apparatus, comprising:
the beam splitter described in claim 10 and
a half wavelength plate.

16. An optical pickup apparatus, comprising:
the beam splitter described in claim 12 and
a quarter wavelength place.

17. The optical pickup apparatus of claim 14, wherein a divergent light flux emitted from the light source enters in the beam splitter.
